(19) United States
(12) Patent Application Publication
(10) Pub. No.: US 2010/0296447 A1
(43) Pub. Date: Nov. 25, 2010

(54) Remote unit, and signal transmission and reception method of remote unit

(75) Inventor: Yuichiro Terasawa, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 12/801,058

(22) Filed: May 19, 2010

(30) Foreign Application Priority Data
May 21, 2009 (JP) 2009-123623

(51) Int. Cl. H04W 4/00

(52) U.S. Cl. 370/328

(57) ABSTRACT

A remote unit including: a first communication apparatus including a first amplification portion that amplifies a signal from a console, the amplified signal being outputted to an information processing apparatus; and a second communication apparatus including a second amplification portion that receives a reply signal to the signal from the information processing apparatus via the first communication apparatus, and amplifies the received reply signal, the reply signal amplified by the second amplification portion being outputted to the console.

### CROSS-REFERENCE TO RELATED APPLICATION

This application is based upon and claims the benefit of priority of the prior Japanese Patent Application No. 2009-123623, filed on May 21, 2009, the entire contents of which are incorporated herein by reference.

### FIELD

A certain aspect of the embodiments discussed herein is related to a remote unit that transmits a signal and a reply signal to the signal over a long distance, and a signal transmission and reception method of the remote unit.

### BACKGROUND

Conventionally, there has been known a remote unit provided between a server and a console (e.g. a keyboard, a mouse, or a monitor) so that the console away from the server by about 100 meters operates the server.

The remote unit includes a local device and a remote device, and the local device and the remote device are connected to each other with a LAN (Local Area Network) cable. The server is connected to the local device, and the console is connected to the remote device.

In this kind of remote unit, the server and the console are connected to each other with the LAN cable within 100 meters. This is because a signal and a reply signal to the signal transmitted between the server and the console are attenuated when a distance between the server and the console is equal to or more than 100 meters, and hence these signals cannot be properly transmitted to the server or the console.

### SUMMARY

According to an aspect of the present invention, there is provided a remote unit including: a first communication apparatus including a first amplification portion that amplifies a signal from a console, the amplified signal being outputted to an information processing apparatus; and a second communication apparatus including a second amplification portion that receives a reply signal to the signal from the information processing apparatus via the first communication apparatus, and amplifies the received reply signal, the reply signal amplified by the second amplification portion being outputted to the console.

According to another aspect of the present invention, there is provided a signal transmission and reception method of a remote unit connected between a console and an information processing apparatus, including: amplifying a signal from the console; outputting the amplified signal to an information processing apparatus; receiving a reply signal to the signal from the information processing apparatus; amplifying the received reply signal; and outputting the amplified reply signal to the console.

### BRIEF DESCRIPTION OF DRAWINGS

FIG. 1 is a diagram showing the configuration of a system including a remote unit according to an embodiment of the present invention;

FIG. 2 is a block diagram showing the schematic configuration of the remote unit;

FIG. 3 is a circuit diagram of an RS485 transceiver 102, an echo cancellation circuit 103, and an equalizer 104; and

FIG. 4 is a circuit diagram of an RS485 transceiver 202, an echo cancellation circuit 203, an equalizer 204, and a filter circuit 206.

### DESCRIPTION OF EMBODIMENTS

A description will now be given, with reference to the accompanying drawings, of an embodiment of the present invention.

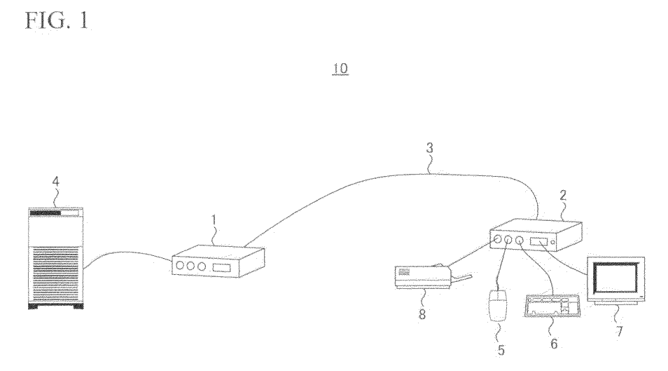

FIG. 1 is a diagram showing the configuration of a system including a remote unit according to an embodiment of the present invention.

In FIG. 1, a system 10 includes a local device 1 (a first communication apparatus), a remote device 2 (a second communication apparatus), a server 4, a mouse 5, a keyboard 6, a monitor 7, and a printer 8. The local device 1 and the remote device 2 compose the remote unit. The local device 1 and the remote device 2 are connected to each other with a Cat5 (Category 5) cable, i.e., a LAN (Local Area Network) cable 3. The length of the LAN cable 3 is 300 meters. The server 4 is connected to the local device 1. The mouse 5, the keyboard 6, the monitor 7, and the printer 8 are connected to the remote device 2. The mouse 5, the keyboard 6, the monitor 7, and the printer 8 function as a console.

The local device 1 receives a video signal (an RGB signal) from the server 4 and a reply signal to a USB (Universal Serial Bus) device signal from the console, and transmits the video signal and the reply signal to the remote device 2 via the LAN cable 3. The local device 1 receives a USB device signal of the mouse 5 and/or the keyboard 6 which the remote device 2 inputs, from the remote device 2 via the LAN cable 3, and transmits the USB device signal to the server 4. The remote device 2 receives the video signal and the reply signal from the local device 1 via the LAN cable 3, and transmits the video signal to the monitor 7. The remote device 2 transmits the USB device signal of the mouse 5 and/or the keyboard 6 to the local device 1 via the LAN cable 3. Thereby, a user can operate the server from the mouse 5 and/or the keyboard 6.

It should be noted that the local device 1 can connect a mouse, a keyboard, and a monitor (not shown). A USB device other than the mouse 5 and the keyboard 6 may be connected to the remote device 2.

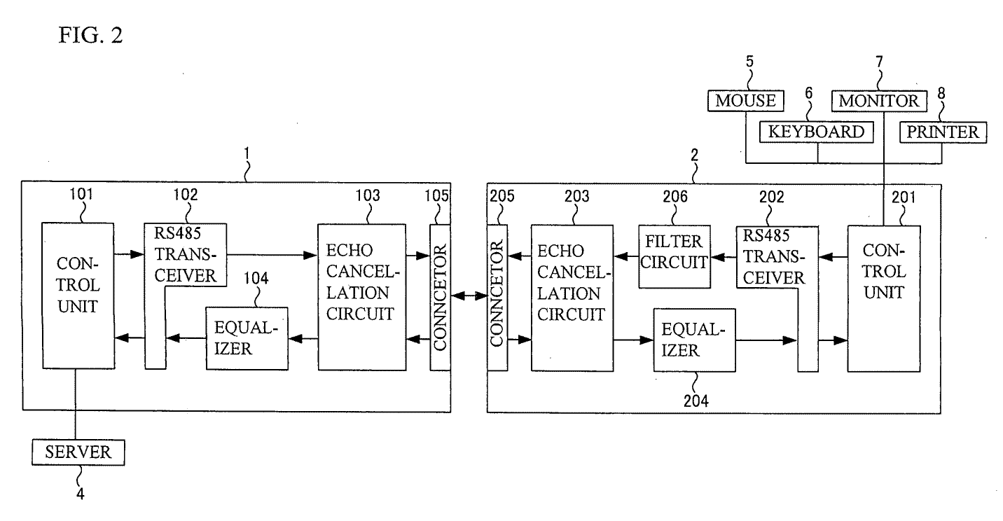

FIG. 2 is a block diagram showing the schematic configuration of the remote unit. FIG. 2 shows the configuration relating to the USB device signal and the reply signal.

The local device 1 includes a control unit 101, an RS485 transceiver 102, an echo cancellation circuit 103, an equalizer 104 (a first amplification portion), and a connector 105. The remote device 2 includes a control unit 201, an RS485 transceiver 202, an echo cancellation circuit 203, an equalizer 204 (a second amplification portion), a connector 205, and a filter circuit 206.

Each of the control units 101 and 201 is composed of a FPGA (Field Programmable Gate Array; a LSI (large-scale integration) that can be operated by a program), and provide a control necessary for transmission and reception of the USB device signal (e.g. switching of an output destination of the USB device signal). The RS485 transceiver 102 outputs the USB device signal received from the remote device 2, to the server 4, and transmits the reply signal to the USB device signal from the server 4, to the remote device 2. The RS485 transceiver 202 transmits the USB device signal from the mouse 5 or the keyboard 6 to the local device 1.

The echo cancellation circuit 103 cancels an input by the reflection of the reply signal transmitted to the remote device 2. The echo cancellation circuit 203 cancels an input by the reflection of the USB device signal transmitted to the local device 1.

The equalizer 104 amplifies the USB device signal received from the remote device 2, and transmits the amplified USB device signal to the control unit 101 via the RS485 transceiver 102. The equalizer 204 amplifies the reply signal received from the local device 1, and transmits the amplified reply signal to the control unit 201 via the RS485 transceiver 202. The connector 105 connects the LAN cable 3 to the echo cancellation circuit 103. The connector 205 connects the LAN cable 3 to the echo cancellation circuit 203.

To prevent the USB device signal to be transmitted to the local device 1 from interfering in other signal (e.g. the video signal) received from the local device 1, the filter circuit 206 reduces the speed of rise and decay of the USB device signal, i.e., makes the output waveform of the USB device signal smooth. Thereby, the rise and decay of the USB device signal become smooth, and it is avoided that a noise enters other signal (e.g. the video signal) received from the local device 1.

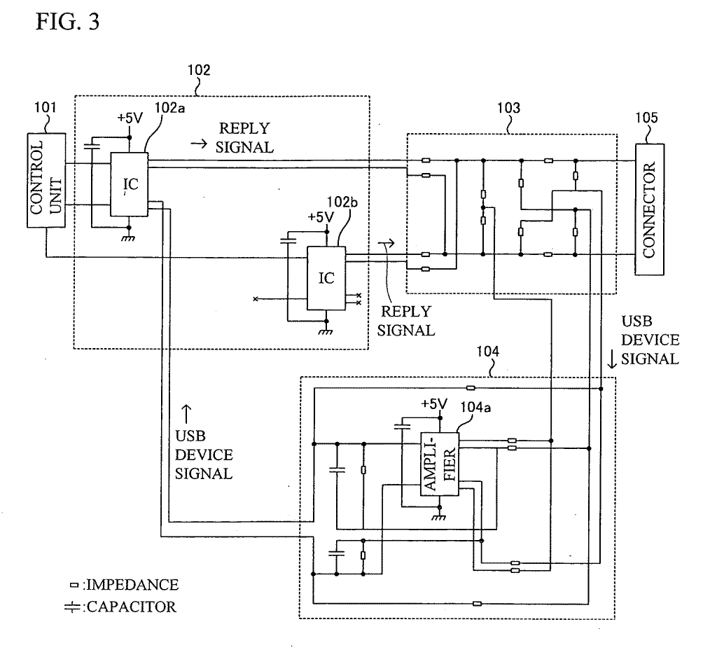

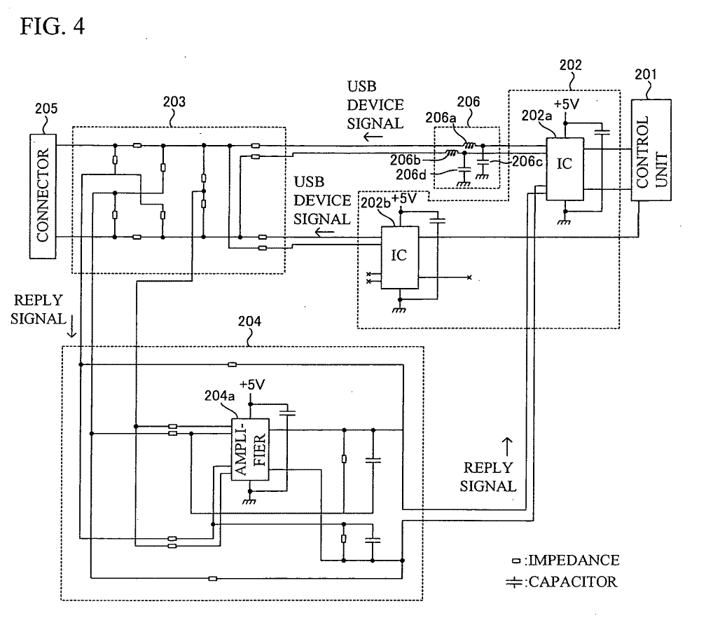

FIG. 3 is a circuit diagram of the RS485 transceiver 102, the echo cancellation circuit 103, and the equalizer 104. FIG. 4 is a circuit diagram of the RS485 transceiver 202, the echo cancellation circuit 203, the equalizer 204, and the filter circuit 206.

As shown in FIG. 3, the RS485 transceiver 102 includes RS485-ICs 102a and 102b. The RS485-IC 102a receives the USB device signal amplified with equalizer 104. The RS485-IC 102b outputs the reply signal to the USB device signal received from the server 4, as differential signals. The echo cancellation circuit 103 is composed of a plurality of impedances. The equalizer 104 includes an amplifier 104a.

The USB device signal from the remote device 2 has an amplitude of 200 mV, and is input to the amplifier 104a. The USB device signal is converted into differential signals of +1.2V/−1.2V with the amplifier 104a. Then, the USB device signal is converted into signals of +5V/0V with the RS485-IC 102a, and the converted signals are transmitted to the control unit 101 as a digital signal.

As shown in FIG. 4, the RS485 transceiver 202 includes RS485-ICs 202a and 202b. The RS485-ICs 202a and 202b output the USB device signal from the mouse 5 or the keyboard 6 as differential signals. The RS485-IC 202a inputs the reply signal to the USB signal, which is received from the local device 1. The echo cancellation circuit 203 is composed of a plurality of impedances. The equalizer 204 includes an amplifier 204a. The filter circuit 206 is composed of coils 206a and 206b connected in series to respective two signal lines, and capacitors 206c and 206d.

The waveform of the USB device signal from the mouse 5 or the keyboard 6 becomes smooth rise and smooth decay by the filter circuit 206. The reply signal from the local device 1 is amplified with the amplifier 204a of the equalizer 204, and transmitted to the control unit 201 via the RS485-IC 202a.

As described in detail above, according to the present embodiment, the local device 1 includes the equalizer 104 that amplifies the USB device signal of the mouse 5 or the keyboard 6, and the local device 1 outputs the amplified USB device signal to the server 4. The remote device 2 includes the equalizer 204 that receives the reply signal from the server 4 via the local device 1, and amplifies the received reply signal. The remote device 2 outputs the reply signal amplified by the equalizer 204 to the console. Therefore, it is possible to transmit the USB device signal and the reply signal to the USB device signal over a long distance, compared to the conventional art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A remote unit comprising:
a first communication apparatus including a first amplification portion that amplifies a signal from a console, the amplified signal being outputted to an information processing apparatus; and
a second communication apparatus including a second amplification portion that receives a reply signal to the signal from the information processing apparatus via the first communication apparatus, and amplifies the received reply signal, the reply signal amplified by the second amplification portion being outputted to the console.

2. The remote unit as claimed in claim 1, wherein the second communication apparatus further includes a filter circuit that reduces the speed of rise and decay of the signal from the console.

3. A signal transmission and reception method of a remote unit connected between a console and an information processing apparatus, comprising:
amplifying a signal from the console;
outputting the amplified signal to an information processing apparatus;
receiving a reply signal to the signal from the information processing apparatus;
amplifying the received reply signal; and
outputting the amplified reply signal to the console.

4. The signal transmission and reception method of the remote unit as claimed in claim 3, further comprising reducing the speed of rise and decay of the signal from the console.
